(19) United States
(12) Patent Application Publication
(10) Pub. No.: US 2015/0381956 A1
(43) Pub. Date: Dec. 31, 2015

(54) IMAGE PROJECTION APPARATUS, IMAGE PROJECTION METHOD, AND STORAGE MEDIUM OF PROGRAM

(71) Applicant: Atsushi TAKAGI, Kanagawa (JP)

(72) Inventor: Atsushi TAKAGI, Kanagawa (JP)

(21) Appl. No.: 14/731,938

(22) Filed: Jun. 5, 2015

(30) Foreign Application Priority Data
Jun. 25, 2014 (JP) 2014-130154

(51) Int. Cl. H04N 9/31; G01P 15/00; G01P 13/00

(52) U.S. Cl. CPC H04N 9/3185; G01P 13/00; G01P 15/00

(57) ABSTRACT

An image projection apparatus to generate a projection image based on image data input to the image projection apparatus and project the projection image includes a motion detector to detect motion of the image projection apparatus, a determination unit to compare a value of the motion detected by the motion detector and a threshold to determine whether the motion occurs to the image projection apparatus, and an outline image generator to generate a first outline image indicating an outline of a first projection area on the projection image when the determination unit determines that the motion occurs to the image projection apparatus.

### CROSS-REFERENCE TO RELATED APPLICATION

This application claims priority pursuant to 35 U.S.C. §119(a) to Japanese Patent Application No. 2014-130154, filed on Jun. 25, 2014 in the Japan Patent Office, the disclosure of which are incorporated by reference herein in their entirety.

### BACKGROUND

1. Technical Field

The present invention relates to an image projection apparatus, an image projection method, and a storage medium that projects images on a screen.

2. Background Art

Image projection apparatuses known as projectors can project images on projection faces such as screens by irradiating light. Typically, projectors receive image data from other apparatuses and projects images such as still images and movie images generated from the received image data. The image data can be transferred from image generation apparatuses such as a television system and computers such as a personal computer (PC) via an interface such as high-definition multimedia interface (HDMI), digital visual interface (DVI), and video graphics array (VGA).

The projectors can be classified into two systems such as a cathode ray tube (CRT) system, and a light valve system. The light valve system modulates light emitted from a light source by using a light valve to project images. For example, liquid crystal projectors, digital light processing (DLP) projectors, liquid crystal on silicon (LCOS) projectors, grating light valve (GLV) projectors employ the light valve system. The liquid crystal projector generates images on a liquid crystal panel, and projects the images on a screen by using light transmitted through the liquid crystal panel (transmission type projector). The DLP projector, LCOS projector, and GLV projector employs an image generation element to which light is irradiated, and reflection light from the image generation element is projected onto a screen (reflection type projector). The DLP projector employs a digital mirror device (DMD) configured with a number of micro mirrors arrayed in a matrix as the image generation element, the LCOS projector employs a reflection type liquid crystal element known as the liquid crystal on silicon (LCOS) as the image generation element, and the GLV projector employs a grating light valve as the image generation element.

Projectors are typically portable projectors which can be carried by users, and placed on tables and/or stands to project enlarged images onto screens.

When a portable projector is used, the projector is required to be set at a suitable position to project images correctly on a projection face such as a screen irradiated by light by conducting a setup adjustment work. The setup adjustment work of the projector can be conducted by adjusting directions of the projector into the upper/lower and left/right directions while visually checking an image projected on the screen (hereinafter, “projection image”), in which left/right positions of the projection image projected on the screen are adjusted, and upper/lower positions of the projection image projected on the screen are adjusted, which means an angle of the projector is adjusted because the projection image may distort into trapezoid when projector has an elevation angle or a depression angle with respect to the screen. However, the setup adjustment work is time-consuming for users.

### SUMMARY

In one aspect of the present invention, an image projection apparatus to generate a projection image based on image data input to the image projection apparatus and project the projection image is devised. The image projection apparatus includes a motion detector to detect motion of the image projection apparatus, a determination unit to compare a value of the motion detected by the motion detector and a threshold to determine whether the motion occurs to the image projection apparatus, and an outline image generator to generate a first outline image indicating an outline of a first projection area on the projection image when the determination unit determines that the motion occurs to the image projection apparatus.

In another aspect of the present invention, a method of generating and projecting a projection image based on image data input to an image projection apparatus is devised. The method includes the steps of detecting motion of the image projection apparatus, comparing a value of the motion detected by the detecting step and a threshold, determining whether the motion occurs to the image projection apparatus based on a comparison result at the comparing step, and generating a first outline image indicating an outline of a first projection area of the projection image when a determination result of the determining step indicates that the motion occurs to the image projection apparatus.

In another aspect of the present invention a non-transitory storage medium storing a program that, when executed by a computer, causes the computer to execute a method of generating and projecting a projection image based on image data input to an image projection apparatus is devised. The method includes the steps of detecting motion of the image projection apparatus, comparing a value of the motion detected by the detecting step and a threshold, determining whether the motion occurs to the image projection apparatus based on a comparison result at the comparing step, and generating a first outline image indicating an outline of a first projection area of the projection image when a determination result of the determining step indicates that the motion occurs to the image projection apparatus.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a perspective view of an image projection apparatus according to one or more example embodiments;

FIG. 2 is a perspective view of the image projection apparatus, in which an outer cover is removed to expose internal parts;

FIG. 3 is a perspective view of a light source unit and an optical unit of the image projection apparatus;

FIG. 4 is a cross-sectional view of the light source unit and the optical unit of FIG. 3;

FIG. 5 is a block diagram of an electrical configuration of each unit of the image projection apparatus;

FIG. 6 is a schematic view of a setup adjustment work for the image projection apparatus;

FIG. 7 is a flowchart showing the steps of a process performable by a main controller;

FIG. 8A is a schematic view of a projection image projected on a screen without performing a setup-adjustment assisting process;

FIG. 8B is a schematic view of a projection image projected on a screen with generating a first outline image by performing a setup-adjustment assisting process;

FIG. 9A is a schematic view of a projection image projected on a screen without performing a setup-adjustment assisting process;

FIG. 9B is a schematic view of a projection image projected on a screen with generating a first outline image and a second outline image by performing a setup-adjustment assisting process when a trapezoid correction is performed;

FIG. 10A is a schematic view of a projection image projected on a screen without performing a setup-adjustment assisting process;

FIG. 10B is a schematic view of a projection image projected on a screen with generating a first outline image and a second outline image by performing a setup-adjustment assisting process when an aspect ratio is different;

FIG. 11 shows gamma profiles used for a gamma correction process;

FIG. 12A is a schematic view of a projection image projected on a screen without performing a setup-adjustment assisting process; and

FIG. 12B is a schematic view of a projection image projected on a screen with generating a first outline image and a second outline image by performing a setup-adjustment assisting process when an aspect ratio is different, in which brightness or luminance of the projection image is decreased.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, one or more apparatuses or systems according to one or more example embodiments are described hereinafter.

### (Configuration of Image Projection Apparatus)

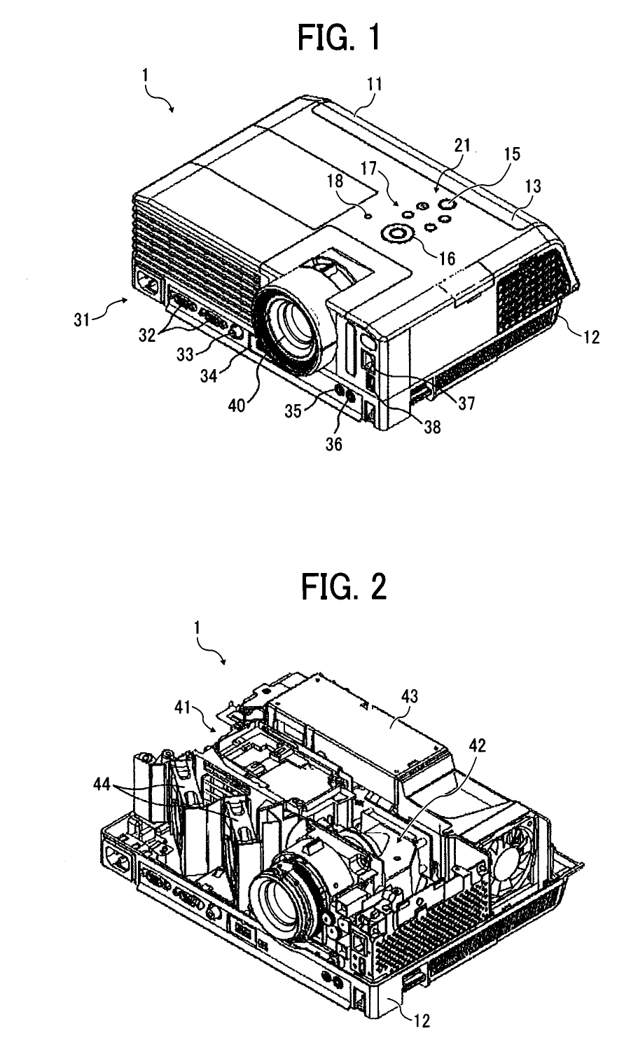

A description is given of an image projection apparatus according to one or more example embodiments. FIG. 1 is a perspective view of an image projection apparatus 1 according to one or more example embodiments. As illustrated in FIG. 1, the image projection apparatus 1 includes, for example, a housing 11, an optical unit 42 (FIGS. 2 to 4), an operation unit 21, and a terminal unit 31, in which the housing 11 has a flat rectangular shape, a part of a projection unit 40 included in the optical unit 42 is exposed at the front face of the housing 11, the operation unit 21 is disposed on the top face of the housing 11, and the terminal unit 31 having various terminals is disposed on the front face of the housing 11. The housing 11 includes, for example, an outer cover 13 and a base 12, in which the outer cover 13 is detachably attached to the base 12. The operation unit 21 includes, for example, a power switch 15, a four-directional switch 16 having an “enter button” at the center, push switches 17 of “menu,” “focus,” “input,” and “AV mute”, and an indicator 18. The terminal unit 31 includes, for example, a computer input terminal 32, an video input terminal 33, a HDMI terminal 34, an audio input terminal 35, an audio output terminal 36, a wired local area network (LAN) terminal 37, and a universal serial bus (USB) terminal 38.

FIG. 2 is a perspective view of the image projection apparatus 1, in which the outer cover 13 is removed to expose internal parts. As illustrated in FIG. 2, most of the units or parts of the image projection apparatus 1 are disposed on the base 12 of the housing 11. The units or parts include, for example, a light source unit 41, the optical unit 42, a power source circuit 43, various fans 44, and also a control circuit 70.

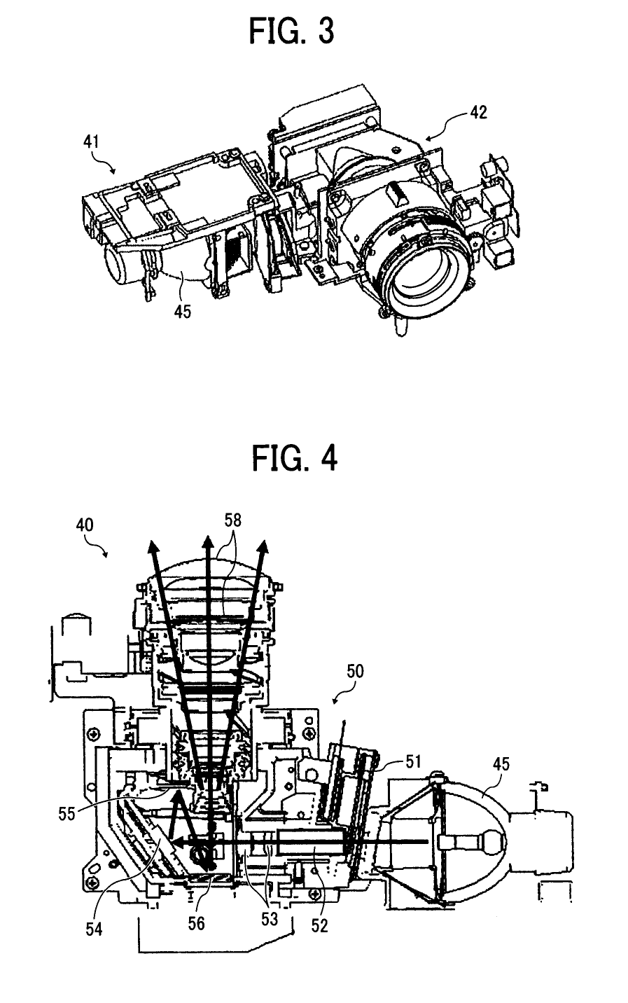

FIG. 3 is a perspective view of the light source unit 41 and the optical unit 42. FIG. 4 is a cross-sectional view of the light source unit 41 and the optical unit 42. As illustrated in FIGS. 3 and 4, the light source unit 41 includes, for example, a lamp 45 as a light source. The lamp 45 employs, for example, a high pressure mercury (vapor) lamp that emits white light to the optical unit 42. As illustrated in FIG. 4, the optical unit 42 includes a lighting unit 50, and the projection unit 40, which employs a digital mirror device (DMD) 56 as an image generation element. The DMD 56 is a reflection-type display element configured with a number of micro mirrors, shaped in rectangular and arrayed in a matrix pattern. The DMD 56 can switch directions of each of the micro mirrors depending on ON/OFF signals.

The lighting unit 50 includes, for example, a color wheel 51, a light tunnel 52, a relay lens 53, a flat mirror 54, and a curved mirror 55. The color wheel 51 converts the white light emitted from the lamp 45 of the light source unit 41 to red, green, and blue (R, G, B) light with a given cyclical time interval, and then the red, green, and blue (R, G, B) light is emitted to the light tunnel 52. The light tunnel 52, made of plate glasses attached into a tube shape, guides the light emitted from the color wheel 51 to the relay lens 53. The relay lens 53, configured with two lenses, corrects chrominance difference/chromatic aberration on an axis of light emitted from the light tunnel 52. The relay lens 53 condenses the light by correcting chrominance difference/chromatic aberration on the axis of light. The flat mirror 54 and the curved mirror 55 reflect and focus the light emitted from the relay lens 53 to the DMD 56.

Based on image data transmitted from an apparatus such as a personal computer (PC) connected to the terminal unit 31 of the image projection apparatus 1, each of the micro mirrors of the DMD 56 is driven time-divisionally, in which ON/OFF signals are applied to the DMD 56 to switch directions of the each of the micro mirrors. With this time-divisional driving, the DMD 56 switches light to enter the projection unit 40 (use light), and light not light to enter the projection unit 40 (non-use light) to generate an image to be projected on a screen.

The projection unit 40 is configured with, for example, a plurality of lenses 58. The projection unit 40 projects the light reflected from the DMD 56 on the screen as an expanded image, in which the light that enters the plurality of lenses 58 of the projection unit 40 is a “use light” reflected from the micro mirrors of the DMD 56, and a “non-use light” is guided to an OFF plate of the projection unit 40. The projection unit 40 can change an enlargement ratio of a projection image PI (see FIG. 6) projected on the screen by changing relative positions of the plurality of lenses.

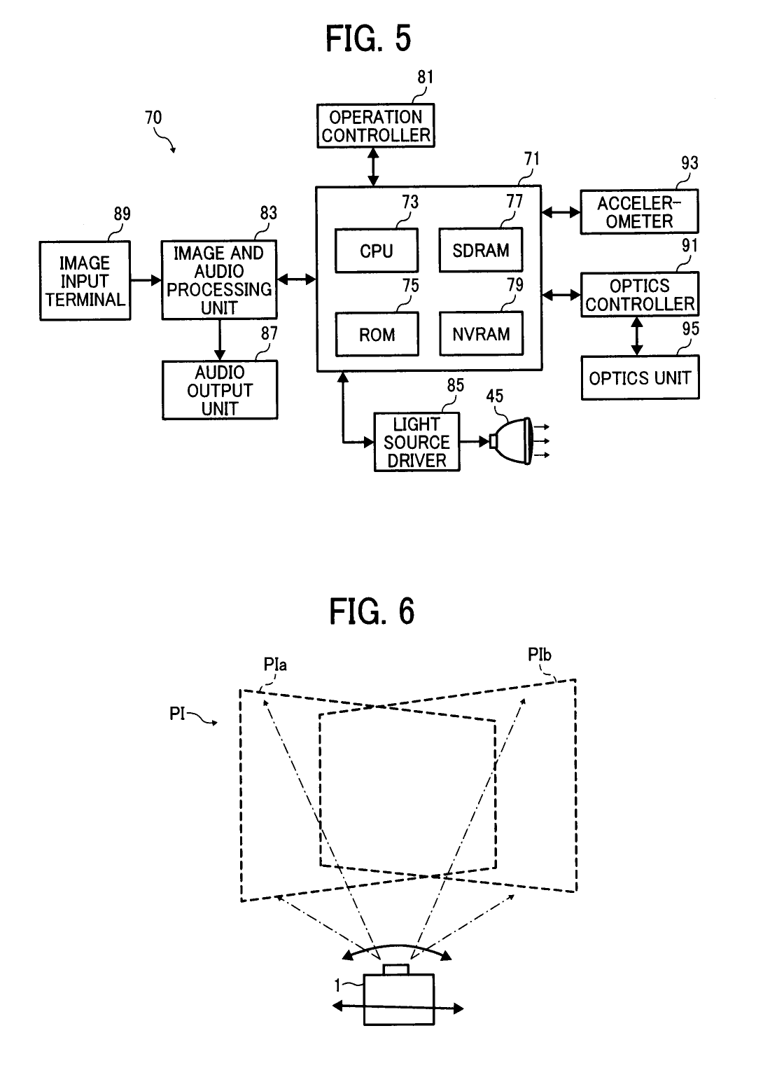

FIG. 5 is a block diagram of an electrical configuration of each unit of the image projection apparatus 1. The control circuit 70 of the image projection apparatus 1 includes a main controller 71. The main controller 71 includes, for example, a central processing unit (CPU) 73 that can perform various processing, a read only memory (ROM) 75, a synchronous dynamic random access memory (SDRAM) 77, and a non-volatile random access memory (NVRAM) 79, which are connectable with each other.

The ROM 75 that can store data permanently without power supply stores basis input/output system (BIOS) and control programs. The SDRAM 77 is a re-writeable memory, to which data can be stored and erased. The CPU 73 uses the SDRAM 77 as a working area for executing the control programs stored in the ROM 75 to control each unit. The NVRAM 79 is a non-volatile memory that can store various settings information even when power supply to the image projection apparatus 1 is stopped.

The main controller 71 can be connected to an operation controller 81, an image and audio processing unit 83, a light source driver 85, an optics controller 91, and an accelerometer 93. The operation controller 81 is a circuit to receive signals from the operation unit 21 and input the received signals to the main controller 71. The CPU 73 of the main controller 71 can perform various processing corresponding to the signals input from the operation controller 81.

The image and audio processing unit 83 is an integrated circuit that receives image data and audio data from an interface such as the image input terminal 89 of the terminal unit 31. The image and audio processing unit 83 adjusts the received image data to RGB image data format process-able by the main controller 71, and outputs the RGB image data to the main controller 71, in which the image and audio processing unit 83 performs a gamma correction or others as required. The image and audio processing unit 83 outputs the received audio data to an audio output unit 87. The audio output unit 87 amplifies analog audio signals, converted from digital audio data, using an amplifier, and outputs the analog audio signal from a speaker.

The light source driver 85 is a circuit that controls an activation of the lamp 45 that emits light. Specifically, the light source driver 85 controls light-ON or light-OFF of the lamp 45 under the command from the CPU 73. The optics controller 91 is an integrated circuit that controls driving of the optics unit 95 such as the optical unit 42 and the DMD 56. The accelerometer 93 is an example of a motion detector or sensor that can detect acceleration occurred to the image projection apparatus 1 having the housing 11 encasing the parts (see FIG. 1). Any sensors that can detect the acceleration can be used for the image projection apparatus 1.

### (Operation of Image Projection Apparatus)

As to the above described configuration, the image projection apparatus 1 can receive image data and/or audio data from an apparatus such as personal computer (PC) connected to the terminal unit 31 via the image input terminal 89. The image and audio processing unit 83 adjusts the received image data to RGB image data format, and transfers the RGB image data to the main controller 71. The image and audio processing unit 83 controls a driving of the audio output unit 87 that can output audio based on the received audio data.

When the RGB image data is transferred from the image and audio processing unit 83, the main controller 7 controls a driving of the color wheel 51 and the DMD 56 to project the RGB image data on a screen, in which the main controller 7 drives each of the micro mirrors of the DMD 56 time-divisionally based on to-be-projected image data. Specifically, ON/OFF signals of pixels (i.e., micro mirrors of the DMD 56) for emitting one of RGB light from the DMD 56 can be generated based on the received image data, in which the generation of ON/OFF signals are synchronized with the rotation movement of the color wheel 51 to switch the directions of micro mirrors of the DMD 56, in which switching of the directions of micro mirrors of the DMD 56 are corresponded to one of RGB color selected by the color wheel 51. This switching of the directions of micro mirrors of the DMD 56 are repeatedly conducted for RGB light with a given cycle sequentially to generate a time-divisional projection image by the DMD 56 based on the received image data.

Each of RGB light, generated by the rotation movement of the color wheel 51 with a given cyclical time interval, enters the light tunnel 52 and the relay lens 53, and then the RGB light is focused on the DMD 56. Then, the reflection light reflected from pixels (micro mirrors of the DMD 56) corresponding to color of image data enters the projection unit 40, and then the light is enlarged and projected on a screen by using the lenses 58 of the projection unit 40. By irradiating the RGB light with a given cyclical time interval, a complete projection image generated from the image data can be projected on the screen as the projection image PI.

### (Setup Adjustment of Image Projection Apparatus)

When projecting an image by utilizing the image projection apparatus 1, the image projection apparatus 1 is required to project a projection image on a correct position on a projection face such as a screen, which is irradiated by light to project the projection image thereon. Therefore, a setup adjustment work is required for the image projection apparatus 1. FIG. 6 is a schematic view of the setup adjustment work for the image projection apparatus 1. As illustrated in FIG. 6, the setup adjustment work of the image projection apparatus 1 can be conducted by adjusting the directions of the image projection apparatus 1 to the upper/lower and left/right directions while visually checking the projection image PI (PIa, PIb) being projected on the screen. A description is given of the setup adjustment work of the image projection apparatus 1.

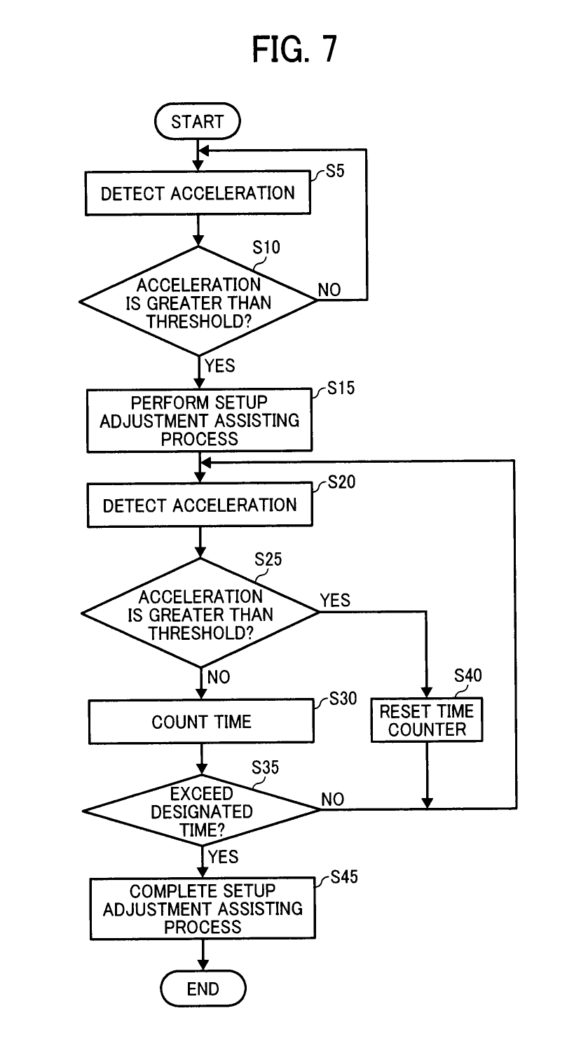

FIG. 7 is a flowchart showing the steps of a process performable by the main controller 71. The CPU 73 of the main controller 71 of the image projection apparatus 1 can sequentially read one or more control programs from the ROM 75 to perform various processing.

At first, the CPU 73 reads a value of acceleration detected by the accelerometer 93 (step S5). Then, the CPU 73 compares a detection value (i.e., acceleration) detected by the accelerometer 93, and a threshold, pre-set and stored in the ROM 75, to determine whether the detection value of acceleration is the threshold or more (step S10). If the CPU 73 determines that the detection value of acceleration is less than the threshold (step S10: NO), the CPU 73 returns the sequence to step S5, and repeats the steps S5 and S10 (waiting process). By contrast, if the CPU 73 determines that the detection value of acceleration is the threshold or more (step S10: YES), the CPU 73 proceeds the sequence to step S15.

The processes at steps S5 and S10 are performed to determine whether the setup adjustment work is actually conducted for the image projection apparatus 1. When the setup adjustment work is conducted for the image projection apparatus 1, the directions of the image projection apparatus 1 are adjusted to the upper/lower and left/right directions as illustrated in FIG. 6, in which the image projection apparatus 1 is shaken, and thereby motion (or movement) occurs to the image projection apparatus 1. Therefore, when the motion occurs to the image projection apparatus 1, it can be estimated that the setup adjustment work is conducted.

However, even if the motion of the image projection apparatus 1 is detected, the detected motion may not always mean that the setup adjustment work is conducted actually. For example, when the operation unit 21 is operated, the image projection apparatus 1 may be shaken or vibrated, or when a desk where the image projection apparatus 1 is placed is shaken, the image projection apparatus 1 may be shaken or vibrated, in which the motion occurs to the image projection apparatus 1 but the motion is not caused by the setup adjustment work.

In view of the motion not related to the setup adjustment work, in the one or more example embodiments, it can be assumed or estimated that the setup adjustment work is conducted when the acceleration of the image projection apparatus 1 becomes a given level or more. Specifically, when a detection value of acceleration detected by the accelerometer 93 becomes a threshold or more, it can be estimated that the setup adjustment work is conducted. The threshold can be stored in one or more control programs as a value for detecting the motion such as acceleration, which indicates the setup adjustment work of the image projection apparatus 1 is conducted.

Referring back to FIG. 7, when the CPU 73 determines that the detection value of acceleration detected by the accelerometer 93 is the threshold or more, the CPU 73 performs a setup-adjustment assisting process (step S15). As to the setup-adjustment assisting process, a first outline image indicating an outline of a projection area of a projection image, generated by the DMD 56, is generated and added to the projection image, and the first outline image and the projection image are collectively projected on the screen, and other related processes are performed. By performing the setup-adjustment assisting process, the setup adjustment work can be simplified. The setup-adjustment assisting process will be described in detail later.

After performing the setup-adjustment assisting process at step S15, the CPU 73 reads a detection value of the acceleration detected by the accelerometer 93 again (step S20), and determines whether the detected value of acceleration is the threshold or more (step S25). If the CPU 73 determines that the detection value of the acceleration is less than the threshold (step S25: NO), the CPU 73 counts time using a time counter implementable using a working area of the SDRAM 77 (step S30). The CPU 73 determines whether the time counted by the time counter elapses a given specific or designated time defined and stored in one or more control programs (step S35). If the CPU 73 determines that the counted time does not exceed the given designated time (step S35: NO), the CPU 73 returns the sequence to step S20.

In the setup-adjustment assisting process, the first outline image indicating an outline of a projection area is generated for a projection image generated by the DMD 56, with which an original projection image is changed. Therefore, when the setup adjustment work of the image projection apparatus 1 is completed, the setup-adjustment assisting process should be ended quickly (step S45).

However, when the setup adjustment work is conducted, the acceleration exceeding the threshold may not occur continuously to the image projection apparatus 1, but the acceleration exceeding the threshold may occur intermittently such as the acceleration exceeding the threshold occurs for some time, and the acceleration exceeding the threshold does not occur for other time.

Therefore, as to the one or more example embodiments, the “designated time” is defined or stored in one or more control programs as a time period to assume that the setup adjustment work is being continued even if the acceleration exceeding the threshold is not detected for the image projection apparatus 1, which means the setup adjustment work is assumed to be continued until the given designated time elapses (step S35: YES).

Based on this concept, if the CPU 73 determines that the detection value of acceleration detected by the accelerometer 93 becomes the threshold or more (step S25: YES) while the time counter is counting the time (steps S20 to S35), the CPU 73 resets the time counter (step S40), and returns the sequence to step S20. In the one or more example embodiments, the designated time defined and stored in one or more control programs does not mean a time period from the start to the end of the setup adjustment work, but means a time period that can be assumed or estimated that the setup adjustment work is completed if the threshold or more acceleration does not occur to the image projection apparatus 1 for the designated time or more.

Therefore, if the acceleration of the threshold or more does not occur to the image projection apparatus 1 for the given designated time (step S35: YES), the CPU 73 ends the setup-adjustment assisting process (step S45).

### (Setup-Adjustment Assisting Process)

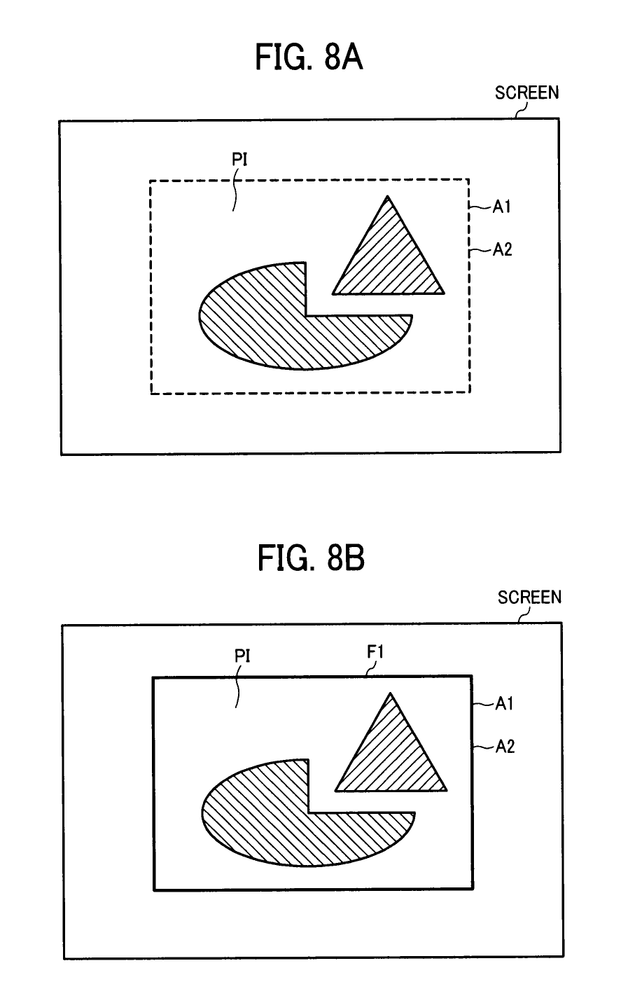

A description is given of the setup-adjustment assisting process executed at step S15 with reference to FIGS. 8 to 12. FIG. 8A is a schematic view of a projection image projected on a screen without performing the setup-adjustment assisting process, and FIG. 8B is a schematic view of a projection image projected on a screen with generating the first outline image by performing the setup-adjustment assisting process. As to FIGS. 8, 9, 10, and 12, an image generated by the DMD 56 may be projected on a first projection area A1 and a second projection area A2.

The first projection area A1 corresponds to an area before performing the image correction such as a size change (e.g., trapezoid correction, aspect ratio correction), which means an image projected on the first projection area A1 does receive the image correction, and thereby the image projected on the first projection area A1 may or may not have image distortion depending on projection conditions.

The second projection area A2 corresponds to an area after performing the image correction such as a size change (e.g., trapezoid correction, aspect ratio correction), which means an image projected on the second projection area A2 receives the image correction, and thereby the image projected on the second projection area A2 does not have image distortion. The second projection area A2 can be used to project a projection image generated from an original image data by the DMD 56 with an optimal projection image size. Therefore, the second projection area A2 can be referred to a size-optimized projection area. The optimal projection image size may be an optimized maximum projection area projectable by the image projection apparatus 1.

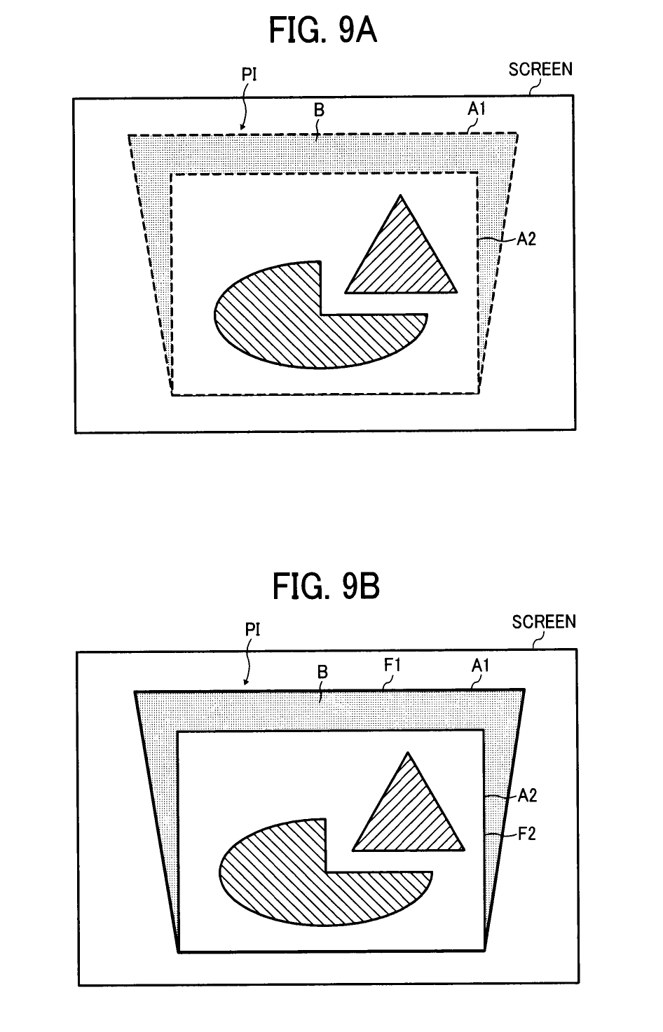

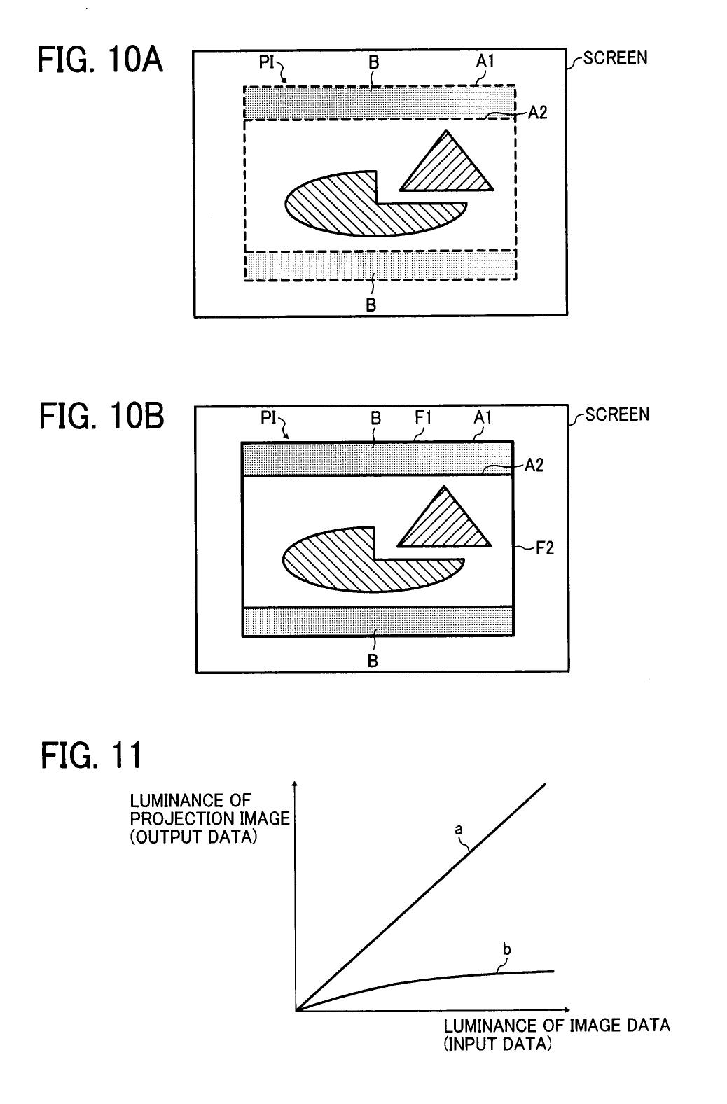

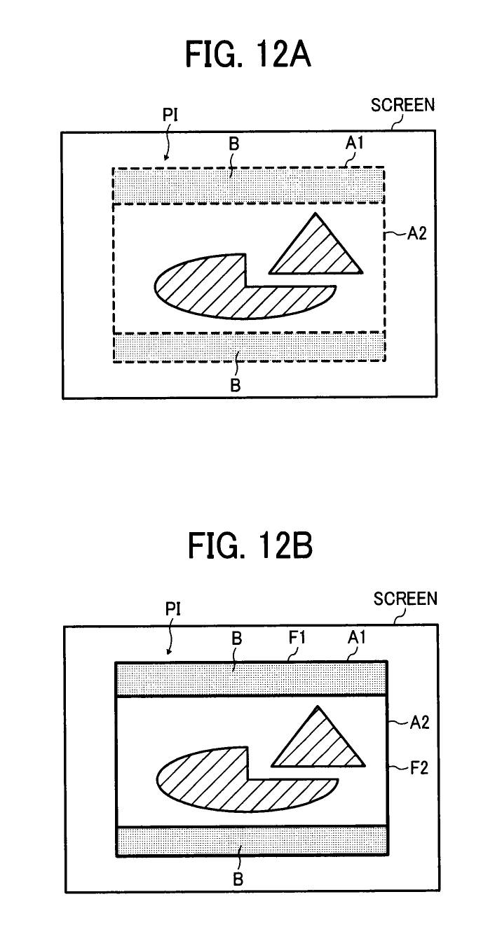

As illustrated in FIGS. 8, 9, 10 and 12, when an image generated by the DMD 56 is projected and displayed on a screen as the projection image PI, the projection image PI can be projected on the first projection area A1. The first projection area A1 is an area without performing the image correction to the image distortion and/or deviation of aspect ratio occurred to the original image data. Therefore, when the image projection apparatus 1 has an elevation angle or depression angle with respect to the screen, the first projection area A1 may become a distorted area such as a trapezoid area as illustrated in FIG. 9. Further, when the aspect ratio is different between the original image data and the image projection apparatus 1, the first projection area A1 may have a blank area B at the upper, lower, right, and/or left area of the projected image as illustrated in FIGS. 10 and 12. Therefore, the first projection area A1 may or may not match to the second projection area A2. For example, the first projection area A1 matches the second projection area A2 in a case of FIG. 8 whereas the first projection area A1 does not match the second projection area A2 in cases of FIGS. 9, 10, and 12.

### (Case One: First Projection Area A1 Matches Second Projection Area A2)

A description is given of a case when the first projection area A1 matches the second projection area A2 with reference to FIG. 8. The setup adjustment work of the image projection apparatus 1 can be conducted by positioning the first projection area A1 (=the second projection area A2) at a suitable position on a screen. However, as illustrated in FIG. 8A, an outline of the projection image PI may not be clearly identified depending on the projection image PI projected on the screen.

For example, when a projected image includes a peripheral area of dark color, a boundary between the projection area and an area outside the projection area may not be clearly identified, and thereby the outline of the projection image PI may not be clearly identified, with which the setup adjustment work of the image projection apparatus 1 becomes difficult to conduct.

Therefore, in the one or more example embodiments, the setup-adjustment assisting process that can generate the first outline image indicating the outline of the projection area of the projection image generated by the DMD 56 is performed. This setup-adjustment assisting process is performed by the CPU 73 using one or more control programs stored in the ROM 75. By performing this setup-adjustment assisting process, as illustrated in FIG. 8B, a first outline F1 corresponding to the first outline image can be generated and displayed for the projection image PI. With this configuration, the setup adjustment work of the image projection apparatus 1 can be simplified.

(Case Two: First Projection Area A1 does not Match Second Projection Area A2)

A description is given of a case when the first projection area A1 does not match the second projection area A2 with reference to FIG. 9. Firstly, a description is given of an issue which may occur when a trapezoid correction is performed with reference to FIG. 9. As illustrated in FIGS. 9A and 9B, when the image projection apparatus 1 has an elevation angle or depression angle with respect to the screen, the projection image PI distorts into a trapezoid. In view of this issue, the image projection apparatus 1 includes a trapezoid correction capability (keystone distortion correction capability). Therefore, when the projection image PI distorts into a trapezoid shape, the trapezoid correction process is performed to project a rectangular-shaped image on the screen as the projection image PI. The trapezoid correction process is a process to apply a change to an original image by pixel conversion (scaling conversion), which can be performed by known methods.

When the trapezoid correction process is performed, as illustrated in FIG. 9A, the second projection area A2 may not match the first projection area A1 which distorts into the trapezoid, and thereby the second projection area A2 may be displayed on the screen as an image smaller than the first projection area A1. Therefore, a partial area in the first projection area A1 not overlapping with the second projection area A2 is displayed on the screen as the blank area B such as a black area. The blank area B can be displayed as the black area, but not limited hereto. The blank area B can be displayed using any image that can indicate that the area B is the blank area.

In this case, a boundary between the blank area B (e.g., black area) and the second projection area A2 used for projection a projection image with an optimized size after receiving the trapezoid correction may not be clearly identified depending on the projection image PI. For example, when the blank area B is displayed as the black area, and the projection image PI has a peripheral area of dark color, the boundary between the blank area B and the second projection area A2 may not be clearly identified, and thereby the outline of the second projection area A2 may not be clearly identified, with which a positioning work of the projection image, which is conducted as the setup adjustment work, is difficult to conduct.

Further, a description is given of an issue which may occur when an aspect ratio is corrected with reference to FIGS. 10 and 12. Typically, the image projection apparatus 1 receives image data from an apparatus connected to the terminal unit 31 via the image input terminal 89, and projects the received image data as the projection image PI, which is projectable on a projection face such as a screen by irradiating light on the screen, in which the image projection apparatus 1 generates a projection image by using the DMD 56 and applying an aspect ratio specifically set to the image projection apparatus 1, and projects the projection image as the projection image PI having the specific aspect ratio. However, the specific aspect ratio may not match the aspect ratio of image data in some cases. Therefore, the image projection apparatus 1 includes the aspect ratio correction capability. When the aspect ratio does not match, the aspect ratio correction process is performed to project the projection image PI onto the screen by applying the aspect ratio of the original image data (see FIGS. 10, and 12). The aspect ratio correction process is a process to apply a change to an original image by pixel conversion (scaling conversion), which can be performed by known methods.

As illustrated in FIGS. 10 and 12, when the aspect ratio correction is performed, the second projection area A2 used for projection a projection image with an optimized size may not match the first projection area A1, and is displayed as an image smaller than the first projection area A1. Therefore, a partial area in the first projection area A1 not overlapping with the second projection area A2 is displayed on the screen as the blank area B such as a black area. The blank area B can be displayed as the black area, but not limited hereto. The blank area B can be displayed using any image that can indicate that the area B is the blank area. The blank area B can be displayed as the black area, but not limited hereto. The blank area B can be displayed using any image that can indicate that the area B is the blank area.

FIGS. 10 and 12 illustrate examples when the aspect ratio of the image data is horizontally-longer compared to the aspect ratio of the projection image generated by the DMD 56, in which the blank area B appears at the upper and lower area of the projection image PI. By contrast, when the aspect ratio of the image data is vertically-longer compared to the aspect ratio of a projection image generated by the DMD 56, the blank area B appears at the left and right area of the projection image PI.

In this case, a boundary between the blank area B (e.g., black area) and the second projection area A2 used for projection a projection image with an optimized size may not be clearly identified. For example, when the blank area B is displayed as the black area, and the projection image PI has a peripheral area of dark color, the boundary between the blank area B and the second projection area A2 may not be clearly identified, and thereby the outline of the second projection area A2 may not be clearly identified, with which a positioning work of the projection image, which is conducted for the setup adjustment work, is difficult to conduct.

In view of the above described issue, an identification process can be performed. The identification process can generate a second outline image indicating the outline of the second projection area A2 for an projection image generated by the DMD 56, in which the first outline image and the second outline image can be generated by performing the identification process to identify the first outline image and the second outline image with each other. In the identification process, color used for the first outline image and color used for the second outline image are set differently. For example, the first outline image can be generated as a red line while the second outline image can be generated as a blue line, but not limited hereto. Each of the first outline image and the second outline image can be generated as any color line as long as the first outline image and the second outline image can be identified with each other. This identification process can be performed by the CPU 73 using one or more control programs stored in the ROM 75. By performing the identification process, as illustrated in FIGS. 9B, 10B and 12B, the first outline F1 corresponding to the first outline image generated for the first projection image A1, and a second outline F2 corresponding to the second outline image generated for the second projection image A2 can be displayed using different colors on the projection image PI. With this configuration, the setup adjustment work of the image projection apparatus 1 can be simplified.

Further, a description is given of adjustment of brightness or luminance of a projection image with reference to FIG. 11. As above mentioned, the image and audio processing unit 83 can perform the gamma correction. The gamma correction can be performed using gamma values, which can be corrected based on a gamma profile. FIG. 11 shows a gamma profile “a” used for a normal operation mode of the image projection apparatus 1, and a gamma profile “b” used for a setup mode of the image projection apparatus 1. Specifically, the gamma profile “a” is used to set a linear relationship between luminance of each of pixels included in image data (input data), and luminance of the projection image PI (output data) displayed on the screen.

When the setup adjustment work of the image projection apparatus 1 is conducted, light emitted from the image projection apparatus 1 may be directed to a person by accident. For example, when the projection image PI is displayed on the screen as illustrated in FIG. 12A, the light emitted from the projection unit 40 may enter human eyes, which causes glare to human eyes.

In view of such glare issue, in one or more example embodiments, when the setup adjustment work of the image projection apparatus 1 is conducted, the image and audio processing unit 83 can perform the gamma correction using the gamma profile “b” shown in FIG. 11 to decrease brightness or luminance of the projection image PI. The CPU 73 supplies gamma correction signals to the image and audio processing unit 83 based on one or more control programs stored in the ROM 75 to perform the gamma correction process by using the image and audio processing unit 83. With this configuration, the brightness or luminance of the projection image PI can be decreased when the projection image PI is projected as illustrated in FIG. 12B.

As to the above described one or more example embodiments, while the motion of the image projection apparatus 1 is being detected, it is estimated that the setup adjustment work is being conducted for the image projection apparatus 1, in which the first outline image indicating the outline of the first projection area A1 of the projection image is generated, and the first outline image is projected onto the projection face. With this configuration, the first outline F1 corresponding to the first outline image indicating the first projection area A1 of the image projection apparatus 1 can be displayed for the projection image PI, and the outline of the first projection area A1 can be displayed or identified clearly as above described, with which visibility of the first projection area A1 can be enhanced, and thereby the setup adjustment work can be simplified.

Further, as to the above described one or more example embodiments, even if the first projection area A1 does not match the second projection area A2 used for projection a projection image with an optimized size, by displaying the second outline F2, the outline of the second projection area A2 can be displayed or identified clearly, with which visibility of the second projection area A2 can be enhanced, and thereby the setup adjustment work of the image projection apparatus can be simplified, and the adjustment work time can be shortened.

When the first outline F1 and the second outline F2 are displayed, the identification process for identifying the first outline F1, which projects the first outline image, and the second outline F2, which projects the second outline image, is performed to prevent confusion of the first outline F1 and the second outline F2, with which the first outline image and the second outline image can be displayed distinctively by using different display styles such as different color lines. Since the first outline F1, which projects the first outline image, and the second outline F2, which projects the second outline image, can be identified by using different color lines, the first outline image and the second outline image can be displayed distinctively without complex processing.

Further, as to the above described one or more example embodiments, when at least the first outline image is being projected by performing the setup-adjustment assisting process and the identification process, brightness or luminance of the projection image can be decreased. Therefore, even if the light emitted from the image projection apparatus 1 is directed to a person by accident when the setup adjustment work of the image projection apparatus 1 is conducted, the light emitted from the image projection apparatus 1 may not cause glare to human eyes.

Further, as to the above described one or more example embodiments, output signals of the accelerometer 93 can be used to determine whether the motion of the image projection apparatus 1 occurs. Therefore, it can effectively determine whether the motion occurs to the image projection apparatus 1 by a simple configuration. Specifically, it can be determined that the motion of the image projection apparatus 1 occurs when the accelerometer 93 detects a pre-set acceleration value or more. Therefore, a micro vibration transmitted to the image projection apparatus 1 may not be detected as the motion of the image projection apparatus 1, and thereby the setup-adjustment assisting process is not performed when the motion caused by the setup adjustment work is not detected, which means the setup-adjustment assisting process is not performed unnecessarily.

Further, as to the above described one or more example embodiments, the setup-adjustment assisting process can be activated when it is determined that the motion occurs to the image projection apparatus 1, and can be continued until the given designated time elapses without detecting the motion of the image projection apparatus 1, with which it can be estimated appropriately that the setup adjustment work is being conducted. With this configuration, while the setup adjustment work is being continued, the first outline F1 projecting the first outline image and the second outline F2 projecting the second outline image do not disappear abruptly, which means the first outline F1 and the second outline F2 can be continuously projected when it is estimated that the setup adjustment work is being conducted.

### (Variant Examples)

Further, variant examples of the above described one or more example embodiments can be devised as follows.

### (Variant Example 1)

As to the first outline image of the above described one or more example embodiments, the first projection area A1 of the projection image (projection image not receiving the size change such as trapezoid correction, aspect ratio correction) generated by the DMD 56 is indicated by the first outline F1, and the first outline F1 can be displayed differently. For example, the outline of the projection area (i.e., first projection area A1) used for projecting a projection image can be displayed as follows. For example, the first outline F1 can be displayed at a some inner side of the first projection area A1, the first outline F1 can be displayed at a some outer side of the first projection area A1, the peripheral area of the first projection area A1 can be displayed as a gradation, and the first outline F1 of the first projection area A1, the first outline F1 at the some inner side or some outer side of the first projection area A1, or the gradation used for the peripheral area of can be displayed with a flashing pattern.

### (Variant Example 2)

As to the second outline image of the above described one or more example embodiments, the second projection area A2 used for projection a projection image with an optimized size, generated by the DMD 56, is indicated by the second outline F2, and the second outline F can be displayed differently. The second outline F2 of the second projection area A2 can be displayed as follows. For example, the second outline F2 can be displayed at a some inner side of the second projection area A2, the second outline F2 can be displayed at a some outer side of the second projection area A2, the peripheral area of the second projection area A2 can be displayed as gradation, and the second outline F2 of the second projection area A2, the second outline F2 at the some inner side or some outer side of the outline of the second projection area A2, or the gradation used for the peripheral area of can be displayed as a flashing pattern.

### (Variant Example 3)

The above described example embodiment is applied to digital light processing (DLP) projectors that employ the DMD 56 as the image display element, but not limited hereto. For example, the above described example embodiment can be applied to other light valve projectors such as liquid crystal projectors, LCOS projectors, and GLV projectors. Further, the setup-adjustment assisting process is not limited to the projectors of light valve system, but can be also applied to the projectors of CRT system. The above described example embodiment can be applied to any projectors that can generate the first outline image and the second outline image by using the image display element, and display the first outline F1 and the second outline F2 on the projection face such as a screen.

### (Variant Example 4)

As to the above described one or more example embodiments, the CPU 73 determines whether the detection value of acceleration detected by the accelerometer 93 is the threshold or more (S10 and S25 of FIG. 7), but not limited hereto. For example, the CPU 73 can determine whether the detection value of acceleration detected by the accelerometer 93 is the threshold or less, whether the detection value of acceleration detected by the accelerometer 93 exceeds the threshold, or whether the detection value of acceleration detected by the accelerometer 93 does not exceed the threshold. As to the above described one or more example embodiments, when the accelerometer 93 detects a pre-set acceleration value or more, it can be determined that the motion of the image projection apparatus 1 occurs, which means that the setup adjustment work of the image projection apparatus 1 is being conducted. Specific conditions and processes to detect the motion of the image projection apparatus 1 can be changed as required.

### (Variant Example 5)

As to the above described one or more example embodiments, the CPU 73 determines whether the time counted by the time counter elapses the given designated time defined or stored in one or more control programs (S35 of FIG. 7). The elapsed time or counted time can be calculated by using various processing. For example, the CPU 73 determines whether the actual elapsed time becomes the given designated time or more, whether the actual elapsed time becomes the given designated time or less, whether the actual elapsed time exceeds the given designated time, or whether the actual elapsed time does not exceed the given designated time. As to the above described one or more example embodiments, the setup-adjustment assisting process can be continued when it is determined that the motion occurs to the image projection apparatus 1, and until the given designated time elapses without detecting the motion of the image projection apparatus 1. Specific conditions and processes to detect the given designated time can be changed as required. Further, other variant examples can be devised as required.

### Effect of Embodiments

### First Embodiment

As to the first embodiment, the image projection apparatus 1 generates a projection image based on image data input to the image projection apparatus 1, and projects the projection image onto a projection face such as a screen. The image projection apparatus 1 includes, for example, a motion detects (e.g., accelerometer 93), and a determination unit and outline image generator (e.g., CPU 73). The CPU 73 (determination unit) compares a value of the motion detected by the accelerometer 93 and a threshold to determine whether the motion occurs to the image projection apparatus 1. The CPU 73 (outline image generator) generates a first outline image indicating an outline of a first projection area on the projection image when the determination unit determines that the motion occurs to the image projection apparatus 1 as a setup-adjustment assisting process of a setup-adjustment work for the image projection apparatus 1. With this configuration, when it is determined that the motion of the image projection apparatus is detected, it is estimated that the setup adjustment work of the image projection apparatus is conducted, and the first outline image indicating the outline of the first projection area is generated on the projection image, and projected on the projection face. Therefore, even when a boundary between the first projection area and an area outside the first projection area may not be clearly identified, the outline of the first projection area can be identified clearly, and visibility of the outline of the first projection area can be enhanced, with which the setup adjustment work of the image projection apparatus can be simplified, and the adjustment work time can be shortened.

### Second Embodiment

As to the second embodiment, the CPU 73 (outline image generator) further generates a second outline image indicating an outline of a second projection area used for projecting the projection image with an optimized size based on original image data. With this configuration, even if the first projection area A1 does not match the second projection area A2 used for projection a projection image with an optimized size, by displaying the second outline F2, the outline of the second projection area A2 can be displayed or identified clearly on the projection image, which means even if the boundary of the second projection area A2 and an area outside the second projection area A2 may not be clearly identified, the second outline F2 of the second projection area A2 can be displayed or identified clearly on the projection image, with which visibility of the second projection area A2 can be enhanced, and thereby the setup adjustment work of the image projection apparatus can be simplified, and the adjustment work time can be shortened.

### Third Embodiment

As to the third embodiment, the CPU 73 (outline image generator) performs an identification process to identify the first outline image and the second outline image with each other by differentiating a display style of the first outline image, and a display style of the second outline image. With this configuration, the confusion of the first outline image and the second outline image can be prevented by distinctively displaying the first outline image and the second outline image.

### Fourth Embodiment

As to the fourth embodiment, the CPU 73 (outline image generator) performs the identification process of the first outline image and the second outline image by differentiating a display color of the first outline image, and a display color of the second outline image. With this configuration, the first outline image and the second outline image can be displayed distinctively without complex processing.

### Fifth Embodiment

As to the fifth embodiment, wherein when the CPU 73 (outline image generator) performs the identification process while projecting at least the first outline image, brightness or luminance of the projection image is decreased. With this configuration, even if the light emitted from the image projection apparatus 1 is directed to a person by accident when the setup adjustment work of the image projection apparatus 1 is conducted, the light emitted from the image projection apparatus 1 may not cause glare to human eyes.

### Sixth Embodiment

As to the sixth embodiment, the motion detector is the accelerometer 93. With this configuration, it can determine whether the motion of the image projection apparatus 1 occurs effectively by a simple configuration.

### Seventh Embodiment

As to the seventh embodiment, the image projection apparatus 1 continues the setup-adjustment assisting process when the determination unit determines that the motion of the image projection apparatus 1 occurs, and until the given designated time elapses without detecting the motion of the image projection apparatus 1. With this configuration, it can be estimated appropriately that the setup adjustment work is being conducted. With this configuration, while the setup adjustment work is being continued, the first outline F1 projecting the first outline image and the second outline F2 projecting the second outline image do not disappear abruptly.

### Eighth Embodiment

As to the eighth embodiment, the method of projecting a projection image and generating the projection image based on image data input to an image projection apparatus is performed. The method includes the steps of detecting motion of the image projection apparatus 1 by using the motion detector such as the accelerometer 93 (step S5), comparing a value of the motion detected by the detecting step and a threshold and determining whether the motion occurs to the image projection apparatus based on a comparison result at the comparing step; and determining whether the motion occurs to the image projection apparatus by comparing a value of the motion detected by the detecting step and a threshold (step S10), and generating a first outline image indicating an outline of a first projection area of the projection image when a determination result of the determining step indicates that the motion occurs to the image projection apparatus 1 as a setup-adjustment assisting process of a setup-adjustment work for the image projection apparatus 1 (step S15). With this configuration, when it is determined that the motion of the image projection apparatus is detected, it is estimated that the setup adjustment work of the image projection apparatus is conducted, and the first outline image indicating the outline of the first projection area is generated on the projection image, and projected on the projection face. Therefore, even when a boundary between the first projection area and an area outside the first projection area may not be clearly identified, the outline of the first projection area can be identified clearly, and visibility of the outline of the first projection area can be enhanced, with which the setup adjustment work of the image projection apparatus can be simplified, and the adjustment work time can be shortened.

### Ninth Embodiment

As to the ninth embodiment, the CPU 73 executes each of steps of the eighth embodiment. With this configuration, when it is determined that the motion of an image projection apparatus 1 is being detected, it is estimated that the setup adjustment work of the image projection apparatus is conducted, and the first outline image indicating the outline of the first projection area can be generated on a projection image, and projected on a projection face.

As to the above described example embodiments, when it is determined that the motion of an image projection apparatus is being detected, it is estimated that the setup adjustment work of the image projection apparatus is conducted, and the first outline image indicating the outline of the first projection area is generated on a projection image, and projected on a projection face. Therefore, even when a boundary between the first projection area and an area outside the first projection area may not be clearly identified, the outline of the first projection area can be identified clearly, with which visibility of the outline of the first projection area can be enhanced, with which the setup adjustment work of the image projection apparatus can be simplified, and the adjustment work time can be shortened.

The present invention can be implemented in any convenient form, for example using dedicated hardware platform, or a mixture of dedicated hardware platform and software. Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions. The illustrated server apparatuses are only illustrative of one of several computing environments for implementing the embodiments disclosed herein. For example, in some embodiments, any one of the information processing apparatus may include a plurality of computing devices, e.g., a server cluster, that are configured to communicate with each other over any type of communication links, including a network, a shared memory, etc. to collectively perform the processes disclosed herein.

The computer software can be provided to the programmable device using any storage medium or carrier medium such as non-volatile memory for storing processor-readable code such as a floppy disk, a flexible disk, a compact disk read only memory (CD-ROM), a compact disk rewritable (CD-RW), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a flash memory, Blu-ray disc (registered trademark), SD card, a solid state memory device or the like, but not limited these. Further, the computer software can be provided through communication lines such as electrical communication line. Further, the computer software can be provided in a read only memory (ROM) disposed for the computer. The computer software stored in the storage medium can be installed to the computer and executed to implement the above described processing. The computer software stored in the storage medium or apparatus of an external apparatus can be downloaded and installed to the computer via a network to implement the above described processing.

The hardware platform includes any desired kind of hardware resources including, for example, a central processing unit (CPU), a random access memory (RAM), and a hard disk drive (HDD). The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C, C++, C#, Java (registered trademark), JavaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps. In the above-described embodiments, at least one or more of the units of apparatus can be implemented as hardware or as a combination of hardware/software combination. Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

Numerous additional modifications and variations for the communication terminal, information processing system, and information processing method, a program to execute the information processing method by a computer, and a storage or carrier medium of the program are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An image projection apparatus to generate a projection image based on image data input to the image projection apparatus and project the projection image, the image projection apparatus comprising:
a motion detector to detect motion of the image projection apparatus;
a determination unit to compare a value of the motion detected by the motion detector and a threshold to determine whether the motion occurs to the image projection apparatus; and
an outline image generator to generate a first outline image indicating an outline of a first projection area on the projection image when the determination unit determines that the motion occurs to the image projection apparatus.

2. The image projection apparatus of claim 1, wherein the outline image generator further generates a second outline image indicating an outline of a second projection area used for projecting the projection image based on the image data.

3. The image projection apparatus of claim 2, wherein the outline image generator performs an identification process to identify the first outline image and the second outline image with each other by differentiating a display style of the first outline image and a display style of the second outline image.

4. The image projection apparatus of claim 3, wherein the outline image generator performs the identification process of the first outline image and the second outline image by differentiating a display color of the first outline image and a display color of the second outline image.

5. The image projection apparatus of claim 3, wherein when the outline image generator performs the identification process while projecting at least the first outline image, brightness of the projection image is decreased.

6. The image projection apparatus of claim 1, wherein the motion detector is an accelerometer that detects acceleration occurring to the image projection apparatus.

7. The image projection apparatus of claim 2, wherein the outline image generator continues to project the first outline image until a given designated time elapses without detecting the motion of the image projection apparatus after the determination unit determines that the motion of the image projection apparatus occurs.

8. A method of generating and projecting a projection image based on image data input to an image projection apparatus, the method comprising the steps of:
detecting motion of the image projection apparatus;
comparing a value of the motion detected by the detecting step and a threshold;
determining whether the motion occurs to the image projection apparatus based on a comparison result at the comparing step; and
generating a first outline image indicating an outline of a first projection area of the projection image when a determination result of the determining step indicates that the motion occurs to the image projection apparatus.

9. A non-transitory storage medium storing a program that, when executed by a computer, causes the computer to execute a method of projecting a projection image and generating the projection image based on image data input to an image projection apparatus, the method comprising the steps of:
detecting motion of the image projection apparatus;
comparing a value of the motion detected by the detecting step and a threshold;
determining whether the motion occurs to the image projection apparatus based on a comparison result at the comparing step; and
generating a first outline image indicating an outline of a first projection area of the projection image when a determination result of the determining step indicates that the motion occurs to the image projection apparatus.
